(19) United States
(12) Patent Application Publication
(10) Pub. No.: US 2022/0343188 A1
(43) Pub. Date: Oct. 27, 2022

(54) PREDICTING CONTENT VIEWS FOR LOCATIONS AT WHICH NO ELECTRONIC CONTENT DISPLAY IS CURRENTLY INSTALLED

(71) Applicant: Volta Charging, LLC, San Francisco, CA (US)

(72) Inventors: Ionel-Alexandru Hosu, Bucharest (RO); David J. Klein, Los Altos, CA (US); Silas M. Toms, San Francisco, CA (US); Han-En Eric Kung, Livermore, CA (US); Anna C.J. Bailey, San Francisco, CA (US)

(21) Appl. No.: 17/852,285

(22) Filed: Jun. 28, 2022

Related U.S. Application Data
(63) Continuation-in-part of application No. 17/725,455, filed on Apr. 20, 2022.
(60) Provisional application No. 63/177,342, filed on Apr. 20, 2021.
(60) Provisional application No. 63/215,725, filed on Jun. 28, 2021.

(51) Int. Cl. G06N 5/02

(52) U.S. Cl. CPC G06N 5/022

(57) ABSTRACT

Techniques are described herein for predicting content exposure that will result from installing a panel at a location at which no panel is currently installed. The location may include at least one electric vehicle charging station (EVCS) that includes an integrated or external panel for displaying content. The techniques involve training a machine learning engine based on information obtained about locations at which panels are already installed. The information used to train the machine learning engine includes, for each existing installation location: (a) features of the location, and (b) exposure data that has been generated for the location. When the machine learning engine has been trained, the trained machine learning engine predicts the content exposure for a location at which no panel has been installed based on the features of that location.

### CROSS REFERENCE TO RELATED APPLICATION, BENEFIT CLAIM

This application is a continuation-in-part of application Ser. No. 17/725,455, filed Apr. 20, 2022, the entire contents of which is hereby incorporated by reference as if fully set forth herein. Application Ser. No. 17/725,455 claims the benefit of Provisional Application 63/177,342, filed Apr. 20, 2021. This application claims the benefit of Provisional Application 63/215,725, filed Jun. 28, 2021, the entire contents of which is hereby incorporated by reference as if fully set forth herein, under 35 U.S.C. § 119(e).

### FIELD OF THE INVENTION

The present invention relates to automated prediction mechanisms and, more specifically, to automated prediction of content views for locations at which no electronic content display is currently installed.

### BACKGROUND

The public is constantly being exposed to content. The mechanisms for exposing content can range from a plane pulling a banner across the sky to alerts sent to the users' personal mobile devices. The nature of the content itself may vary, from emergency announcements and public service messages, to entertainment content and advertisements.

Content may also be targeted towards a specific segment of the public. For example, a company may conduct a targeted advertising campaign to reach specific demographics that are more likely to be receptive to the company's products and services. One demographic of interest includes electric vehicle (EV) users, who may be targeted by companies selling solar power products and installation services, for example. One popular way to expose users to content is to display the content on an electronic content display (i.e. “panel”) that is within the view of the users. Such panels have a variety of forms, including but not limited to LED and plasma display screens, video projector/screen combinations, touch sensitive display screens, etc.

Example uses of such panels include panels placed at each entrance to a mall to display an interactive map of the mall to enable users to quickly find their way to their desired destination. As another example, panels may be placed on the tables at a restaurant to allow customers to view the menu, place orders, and even play games. Recently, it is even common to view content, while pumping gas, on panels built into or near gasoline pumps or EV charging stations (EVCS).

The value of a panel is largely based on the number of users that will be exposed to (have the opportunity to view) the content played thereon. Thus, the panels located around Times Square in New York City are extremely valuable, while similar panels located in a remote mountain top would have very little value. Because it can be expensive to install and operate panels, it is important to select installation sites that will result in sufficient content exposures to make the investment worthwhile.

Unfortunately, it is much easier to ascertain the amount of content exposure a panel produces after the panel has been installed than when selecting an installation site for a new panel installation. For example, third party vendors may provide auditing services that estimate the amount of content exposure that occurs at existing panel locations. Locations at which panels have already been install are referred to herein as “Existing Installation Locations” or “EILs”.

Unfortunately, it is not particularly helpful to find out that a particular site results in unacceptably low content exposure after the investment has been made to install and operate a panel at the site. It would be vastly more useful to be able to accurately predict content exposure at sites for which no panel is currently installed, for the site selection process to be informed by such predictions. Sites at which no panel has been installed are referred to herein as “Candidate Installation Locations” or “CILs”.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a block diagram illustrating a geographic region that has a set of existing installation locations (EILs) at which panels are already installed and a set of candidate installation locations (CILs) at which no panel is currently installed;

FIG. 2 is a flowchart illustrating steps for predicting content exposure at candidate installation locations at which no panel is currently installed, according to an embodiment; and

FIG. 3 is a block diagram of a computer system upon which the techniques described herein may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

I. General Overview

II. Content Exposure Metrics

III. Location Features

IV. Exposure Data Prediction Process

V. CILs For Which Location Feature Data Is Not Available

VI. The Machine Learning Engine

VII. Hardware Overview

VIII. Cloud Computing

I. General Overview

Techniques are described herein for predicting content exposure that will result from installing a panel at a CIL. Because no panel is currently present at the CIL, conventional auditing techniques are not available for determining the content exposure that would be produced by installing a panel at the CIL. The techniques involve training a machine learning engine based on information obtained about EILs. The information used to train the machine learning engine includes, for each EIL: (a) features of the EIL, and (b) exposure data that has been generated for the EIL.

When the machine learning engine has been trained using the features and exposure data from the EILs, the trained machine learning engine predicts the content exposure for a CIL based on the features of the CIL. The machine learning engine may be used to predict the exposure data for each of multiple CILs that are being considered for the installation of a panel. Thus, the location selection for panel may be performed based, at least in part, on the exposure data predicted for each of the multiple CILs under consideration.

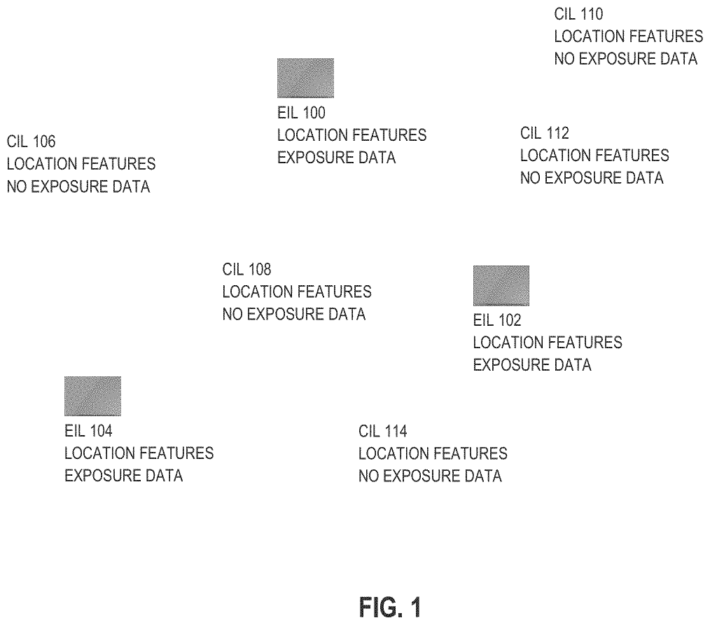

Referring to FIG. 1, it is a block diagram illustrating a situation where three panels have already been installed, and five locations are being considered for the installation of a fourth panel. The three panels are installed at existing installation locations 100, 102 and 104. For each of the existing installation locations, both location feature data and exposure data are known. For each of the five candidate installation locations 106, 108, 110, 112 and 114, location features are known but exposure data is unavailable. To predict exposure information for CILs 106, 108, 110, 112 and 114, a machine learning engine is trained on the location features and exposure data for each of EILs 100, 102 and 104, as shall be described in detail hereafter.

In some implementations, the EILs and/or CILs considered in the machine learning engine may be filtered or otherwise limited to locations having at least one electric vehicle charging station (EVCS), which further includes at least one integrated panel or an externally connected wired or wireless panel for exposing content. The EVCS is a device/entity at a point of interest, such as an EIL or CIL, which facilitates charging of an electric vehicle. The EVCS may comprise various programs, modules, or software applications, including an operating system and software application. The EVCS may receive actions comprising instructions, requests, notifications, and/or recommendations to execute or display from local storage, a wired or wireless intranet, or a remote server computer connected to a wide area network such as the Internet. The actions may include instructions to expose or display content on the integrated or external panel of the EVCS.

II. Content Exposure Metrics

Content exposure can be measured in a variety of ways. For the purpose of explanation, the exposure metrics “monthly impressions” and “impressions per-content-play” shall be used in the examples given herein. “Monthly impressions” generally refers to how many distinct users were exposed to content during a month. “Impressions per-content-play” generally refers to how many distinct users were exposed to content each time the content was played. While examples shall be given herein using the “monthly impression” and “impressions per-content-play” metrics, the techniques described herein are not limited to any particular metrics for measuring content exposure.

In one embodiment, the impressions per-content-play metric can be computed directly from the monthly impression metric as follows.

imp_per content_play=(monthly_impressions)/28/1000.

which assumes 28 days in a month and 1000 content plays per day.

As mentioned above, content exposure metrics for EILs may be available from third-party auditing services. For example, an auditing service may employ a mechanism for determining the monthly_impressions metric for content played on the panels at EILs. Using the techniques described herein, similar content expose metrics may be predicted for CILs, and may be used as a factor in selecting at which CIL to install a panel.

III. Location Features

A location for which “location features” are available is referred to herein as a Point-of-Interest or “POI”. As mentioned above, location features of EILs are used in combination with the content exposure metrics of the EILs (e.g. the monthly impression data from an auditing service) to train the machine learning engine. After the machine learning engine has been trained, location features of CILs are fed to the trained model to generate predictions of content exposure metrics for CILs. Thus, in this scenario, both EILs and CILs qualify as POIs.

The location features of POIs may come from a variety of sources. For example, in one embodiment, the location features used to train the machine learning engine to predict exposure metrics include features obtained from the US Census data, features available from public data sources, and features obtained from various third-party services, which may include features tracked from mobile device data, features derived from user interactions with devices located at POIs, or features gathered by other techniques.

With respect to the features obtained from the US Census, the US Census aggregates data collection into “block groups”, where each block group corresponds to a specific geographic area. Thus, the total population value for a POI is considered to be the total population number from the latest US Census for the block group that corresponds to the specific geographic area in which the POI resides.

According to one embodiment, the location features used to train the machine learning engine to predict exposure metrics of CIL include:
‘gte_construction_type’ Gaussian transform encoding of the categorical feature construction_type. A Gaussian transform is used to make the distribution of this feature resemble a Gaussian distribution.
‘population_male’ The male population of the block group (from US Census)
‘population_total’ The total population of the block group (from US Census)
‘>240’ Number of people who spent 240 minutes or more at the POI
‘61-240’ Number of people who spent between 61 and 240 minutes at the POI.
‘ESTIMATED VISITOR COUNTS’ Estimated number of visitors in a month for a given POI.
‘num_adults’ The number of adults in the block group (from US Census)
‘population_female’ The female population of the block group (from US Census)
‘<5’ Number of people who spent 5 minutes or less minutes at the POI.
‘RAW_VISIT_COUNT’ The recorded number of visits at the POI.
Projected content exposure, or a projected number of audience impressions for a defined period and/or a specific time of day, day of week, month of year, season, holiday period, etc.
Estimated effectiveness of an advertising campaign associated with the projected content exposure, which may be based on actual effectiveness determined from exposure data recorded for one or more similar EILs, wherein the exposure data may also include sales data. For example, an Advertising-to-Sales Ratio can be projected for the CIL based on exposure data, including sales data, recorded for one or more EILs having similar characteristics as the CIL.

This list of features is merely an example of the location features that may be used to train a machine learning engine to predict exposure metrics of CILs. The techniques described herein are not limited to any particular location features, nor to any particular source of information about those features.

IV. Exposure Data Prediction Process

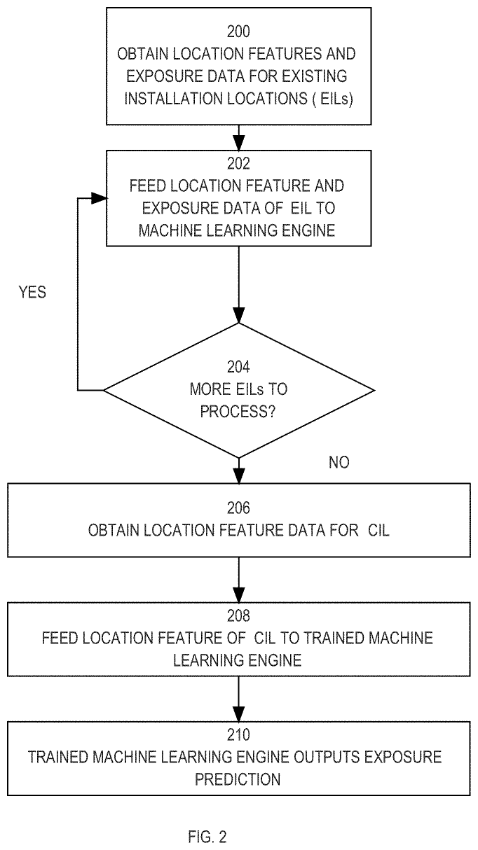

Referring to FIG. 2, it is a flowchart illustrating the general steps for predicting exposure metrics for CILs, according to an embodiment. At step 200, location features and exposure data for EILs are obtained. As discussed above, the location features may be obtained from sources such as the US Census and various third-party services. The exposure metrics for EILs may be obtained from various third-party auditing services.

At step 202, the location feature and exposure data for an EIL is fed into the machine learning engine to train the model used by the machine learning engine. Step 204 forms a loop, causing step 202 to be repeated for each EIL. After all EILs have been processed in this manner, the machine learning engine is trained, and control passes to step 206.

At step 206, location feature data is obtained for a CIL. The location feature data for the CIL may be obtained from the same sources that were used to obtain the feature data for the EILs. At step 208, the location feature data for the CIL is fed to the trained machine learning engine, causing the trained machine learning engine to output an exposure prediction for the CIL. The exposure prediction may be, for example, the monthly impressions that would be produced if a panel were installed at the CIL in question. From the monthly impression prediction, other exposure data may be derived, such as the number of impressions per content play.

The machine learning engine may be retrained periodically to ensure the model produces the most accurate predictions possible. For example, steps 200-204 may be repeated in response to newly available census data, newly created POIs, new location data for existing POIs, and/or new exposure data for existing EILs.

V. CILs for which Location Feature Data is not Available

In some cases, a CIL may not map to a single POI for which location feature data is available. For example, a CIL may fall on the boundary between two census block groups. As another example, a CIL may be surrounded by POIs, but not exactly correspond to any specific POI. According to one embodiment, location feature data for such CILs is derived from the location feature data of the surrounding POIs. The derived location feature data may be obtained by aggregating location feature data from the surrounding POIs.

For example, in the case of a CIL that resides on the border between two census block groups, the total population value for the CIL may be derived by taking the average of the total populations of the two census block groups. Similarly, for a CIL that is surrounded by multiple POIs (e.g. POIs within a threshold distance of the CM), the location feature data for the CM may be derived by taking the average of the location feature data of those POIs. In one embodiment, the average may be weighted, giving greater weight to the location feature data from POIs that are closer to the CM, and less weight to the location feature data from POIs that are farther from the CM.

VI. The Machine Learning Engine

The techniques described herein are not limited to any particular type of machine learning engine. For example, in one embodiment, a neural network is trained to predict exposure data using the training data described above. In an alternative embodiment, a RandomForestRegressor ensemble model is used.

VII. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

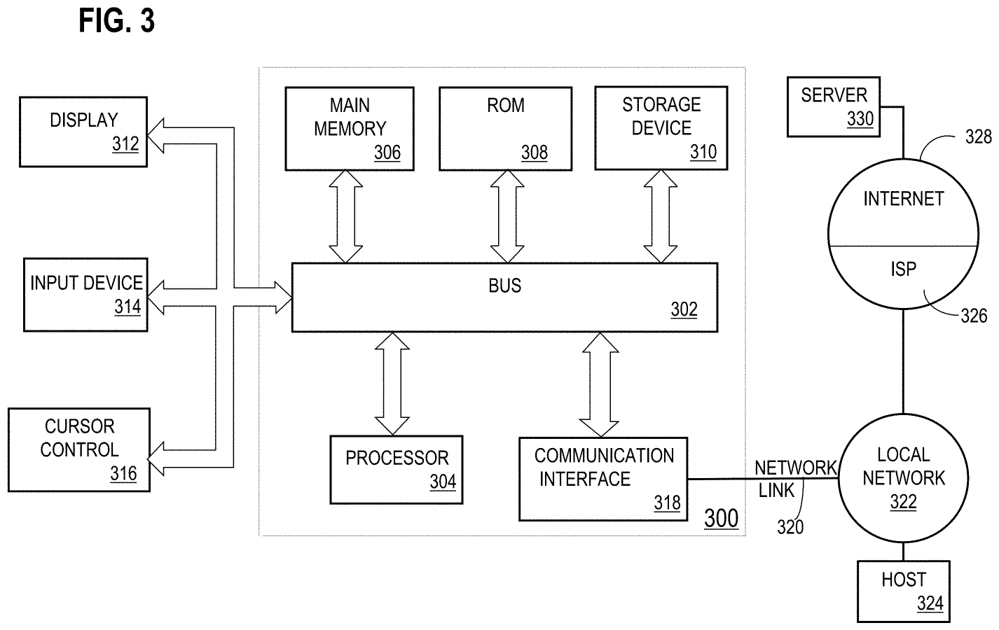

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general-purpose microprocessor.

Computer system 300 also includes a main memory 306, such as a random-access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic, or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic, or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

VIII. Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
producing a trained machine learning engine by training a machine learning engine to predict exposure data for locations at which panels are not currently installed;
wherein training the machine learning engine is performed based, at least in part, on:
location features for each existing installation location of a plurality of existing installation locations at which panels for displaying video content are already installed; and
exposure data for each existing installation location of the plurality of existing installation locations; and
causing the trained machine learning engine to predict content exposure for a particular location at which no panel is currently installed by providing, to the trained machine learning engine, location features for the particular location;
wherein the method is performed by one or more computing devices.

2. The method of claim 1 further comprising:
obtaining, from a particular source, data for a particular location feature for a plurality of points of interests (POIs);
wherein the plurality of POIs include POIs that correspond to the plurality of existing installation locations;
wherein the plurality of POIs do not include any POI that corresponds to the particular location;
wherein the plurality of POIs include a particular set of POIs that are within a threshold distance of the particular location; and
deriving data for the particular location feature for the particular location based on data, for the particular location feature, from the particular set of POIs.

3. The method of claim 2 wherein deriving data for the particular location feature for the particular location includes aggregating data, for the particular location feature, from the particular set of POIs.

4. The method of claim 3 wherein aggregating data, for the particular location feature, from the particular set of POIs includes deriving a weighted average, wherein weight applied to the particular location feature for each POI in the particular set of POIs is based, at least in part, on distance of the POI from the particular location.

5. The method of claim 1 wherein causing the trained machine learning engine to predict content exposure for the particular location includes causing the trained machine learning engine to predict monthly impressions that would occur if a panel were installed at an electric vehicle charging station (EVCS) of the particular location.

6. The method of claim 1 wherein the location features include one or more statistics for a census block group that corresponds to an area in which the particular location is located.

7. The method of claim 6 wherein the one or more statistics include total population for the census block group.

8. The method of claim 1 further comprising:
obtaining, from a particular source, data for a particular location feature for a plurality of points of interests (POIs);
wherein the plurality of POIs include POIs that correspond to the plurality of existing installation locations; and
wherein, for each existing installation location, the location features include one or more statistics relating to number of people that spent an amount of time at the POI, of the plurality of POIs, that corresponds to the existing installation location.

9. The method of claim 1 further comprising:
obtaining, from a particular source, data for a particular location feature for a plurality of points of interests (POIs);
wherein the plurality of POIs include POIs that correspond to the plurality of existing installation locations; and
wherein, for each existing installation location, the location features include a construction type associated with the POI, of the plurality of POIs, that corresponds to the existing installation location.

10. The method of claim 1 further comprising:
obtaining, from a particular source, data for a particular location feature for a plurality of points of interests (POIs);
wherein the plurality of POIs include POIs that correspond to the plurality of existing installation locations; and
wherein, for each existing installation location, the location features include one or more statistics relating to number of visits to the POI, of the plurality of POIs, that corresponds to the existing installation location.

11. The method of claim 1 further comprising:
causing the trained machine learning engine to predict content exposure for each candidate location, of a plurality of candidate locations, at which no panel is currently installed; and
selecting a candidate location, from the plurality of candidate locations, at which to install a panel based, at least in part, on the content exposure predicted for each candidate location.

12. A system comprising:
one or more processors;
one or more storage devices operatively coupled to the processor;
instructions, stored on the one or more storage devices, which, when executed by the one or more processors, cause:
producing a trained machine learning engine by training a machine learning engine to predict exposure data for locations at which panels are not currently installed;
wherein training the machine learning engine is performed based, at least in part, on:
location features for each existing installation location of a plurality of existing installation locations at which panels for displaying video content are already installed; and
exposure data for each existing installation location of the plurality of existing installation locations; and
causing the trained machine learning engine to predict content exposure for a particular location at which no panel is currently installed by providing, to the trained machine learning engine, location features for the particular location.

13. The system of claim 12 wherein the instructions further comprise instructions for:
obtaining, from a particular source, data for a particular location feature for a plurality of points of interests (POIs);
wherein the plurality of POIs include POIs that correspond to the existing installation locations;
wherein the plurality of POIs do not include any POI that corresponds to the particular location;
wherein the plurality of POIs include a particular set of POIs that are within a threshold distance of the particular location; and
deriving data for the particular location feature for the particular location based on data, for the particular location feature, from the particular set of POIs.

14. The system of claim 13 wherein deriving data for the particular location feature for the particular location includes aggregating data, for the particular location feature, from the particular set of POIs.

15. The system of claim 14 wherein aggregating data, for the particular location feature, from the particular set of POIs includes deriving a weighted average, wherein weight applied to the particular location feature for each POI in the particular set of POIs is based, at least in part, on distance of the POI from the particular location.

16. The system of claim 12 wherein causing the trained machine learning engine to predict content exposure for the particular location includes causing the trained machine learning engine to predict monthly impressions that would occur if a panel were installed at an electric vehicle charging station (EVCS) of the particular location.

17. The system of claim 12 wherein the instructions further comprise instructions for:
causing the trained machine learning engine to predict content exposure for each candidate location, of a plurality of candidate locations, at which no panel is currently installed; and
selecting a candidate location, from the plurality of candidate locations, at which to install a panel based, at least in part, on the content exposure predicted for each candidate location.

18. The system of claim 12 where the machine learning engine comprises a neural network.

19. The system of claim 12 wherein the machine learning engine comprises a Random Forest Regressor ensemble model.

20. The method of claim 1 wherein the location features include a projected effectiveness of an advertising campaign associated with the predicted content exposure, and wherein the exposure data of the plurality of existing installation locations includes sales data.
